(19) United States
(12) Patent Application Publication
(10) Pub. No.: US 2008/0293885 A1
(43) Pub. Date: Nov. 27, 2008

(54) Reactive Emulsion and Process for Producing the Same

(75) Inventors: Masakazu Morimoto, Osaka (JP); Naofumi Tsujino, Osaka (JP)

Correspondence Address: BUCHANAN, INGERSOLL & ROONEY PC, POST OFFICE BOX 1404, ALEXANDRIA, VA, 22313-1404, US

(73) Assignee: NIPPON SHOKUBAI CO., LTD., Osaka-shi (JP)

(21) Appl. No.: 11/918,198

(22) PCT Filed: Apr. 19, 2006
(86) PCT No.: PCT/JP2006/308675

§ 371 Date: Oct. 12, 2007

(30) Foreign Application Priority Data
Apr. 20, 2005 (JP) 2005-122442

(51) Int. Cl. C08L 79/04; C08L 81/00

(52) U.S. Cl. 524/876; 524/879

(57) ABSTRACT

The present invention provides a reactive emulsion capable of exerting a superior cross-linking ability, while reducing an amount of expensive additionally polymerizable oxazoline to be used. The problem can be solved with a reactive emulsion containing a core part composed of fine particles of an acrylate-based emulsion and a shell part composed of a polymer containing an oxazoline group, locating around said core part.

### TECHNICAL FIELD

The present invention relates to a reactive emulsion having a polymer layer containing an oxazoline group in shell part thereof, a process for producing the same, an emulsion composition containing said reactive emulsion, and a resin composition for processing cellulose-based substrate containing said emulsion composition.

### BACKGROUND ART

Conventionally, it has been known that an emulsion having an oxazoline group is useful as a cross-linking agent for a water-based resin and capable of improving water resistance, solvent resistance, strength, thermal resistance, etc. of water-based resin. Further, it has also been known that a coating film of an emulsion having an oxazoline group shows good adhesion to a substrate (see U.S. Pat. No. 4,460,029, JP-B-61-89217, JP-A-2-99537, JP-A-2000-119968, and JP-A-2000-129144). However, in the present circumstances, since oxazoline compounds are extremely expensive and also the resulting emulsion consequently becomes expensive, applications thereof are limited.

### DISCLOSURE OF THE INVENTION

Thus, an object of the present invention is to provide a novel reactive emulsion which uses less amount of oxazoline compound and can exhibit an effect such as adhesive property equivalent to or greater than the conventional emulsion, a process for producing the same, an emulsion composition containing said reactive emulsion, and a resin composition for processing a cellulose-based substrate containing said emulsion composition.

The object can be achieved by means of the following items (1) to (11).

(1) A reactive emulsion containing a core part composed of fine particles of an acrylate emulsion, and a shell part composed of a polymer containing an oxazoline group, located around said core part;
(2) An emulsion according to the above item (1), wherein a ratio of said shell part to 100 parts by weight of said core part is 1 to 900 parts by weight;
(3) An emulsion according to the above item (1) or (2), wherein a ratio of an additionally polymerizable oxazoline in said shell part is not less than 1% by weight;
(4) A process for producing a reactive emulsion, containing a step of polymerizing a monomer or a monomer mixture containing, as an essential component, an additionally polymerizable oxazoline with an acrylate-based emulsion in the presence of an emulsifier;
(5) A process according to the above item (4), wherein a ratio of a monomer or a monomer mixture containing an additionally polymerizable oxazoline to 100 parts by weight of solid content of said acrylate-based emulsion is 1 to 900 parts by weight;
(6) A process according to the above item (4) or (5), wherein said monomer or monomer mixture contains not less than 1% by weight of an additionally polymerizable oxazoline;
(7) An emulsion composition containing the reactive emulsion according to any one of the above items (1) to (3) and other polymer;
(8) An emulsion composition according to the above item (7), wherein said other polymer has, as an essential component, one or more functional groups selected from a group consisting of carboxyl group, aromatic thiol group and phenolic hydroxyl group;
(9) A resin composition for processing a cellulose-based substrate containing, as an essential component, the emulsion composition according to the above item (7) or (8);
(10) A resin composition for processing a cellulose-based substrate according to the above item (9), wherein said composition further contains a compound having a functional group capable of reacting with both of a hydroxyl group and one or more functional groups selected from a group consisting of carboxyl group, aromatic thiol group and phenolic hydroxyl group;
(11) A resin composition for processing a cellulose-based substrate according to the above item (9) or (10), wherein said composition further contains, as an essential component, at least one of a compound having an acid anhydride group or a compound having a functional group capable of reacting with a hydroxyl group and a carboxyl group.

Other objects, features and advantages of the present invention will be clarified by referring to preferable embodiments exemplified in the following explanation.

### DETAILED DESCRIPTION OF THE EMBODIMENT

The reactive emulsion according to the present invention contains a core part composed of fine particles of an acrylate-based emulsion and a shell part composed of a polymer containing an oxazoline group, located around said core part. In this connection, “core part” means a core part locating at a center part (inner layer) in a core-shell type reactive emulsion of the present invention, and “shell part” means a shell part located in a circumference (outer layer) of the core part in the emulsion. Therefore, the emulsion of the present invention is not limited to an embodiment, in which a “shell part” exists only in an outermost layer as a very thin layer, but in some instances, a shell part, which is considerably greater than the core part, may exist around of a core part.

Composition of the fine particles of the acrylate-based emulsion as a core part is not particularly limited. As an example, a monomer of polymer (A) constituting the fine particles as a core part includes (meth)acrylate esters such as methyl (meth)acrylate, butyl (meth)acrylate and 2-ethylhexyl (meth)acrylate; unsaturated nitrile compounds such as (meth)acrylonitrile; unsaturated amides such as (meth)acrylamide and N-methylol(meth)acrylamide; vinyl esters such as vinyl acetate and vinyl propionate; vinyl ethers such as methyl vinyl ether and ethyl vinyl ether; α-olefins such as ethylene and propylene; halogen-containing α, β-unsaturated monomers such as vinyl chloride, vinylidene chloride and vinyl fluoride; α,β-unsaturated aromatic monomers such as styrene and α-methylstyrene, and a mixture of one or more monomers thereof may be used.

In the core part of the emulsion of the present invention, concentration of a functional group which has high reactivity to an oxazoline group (hereinafter, referred to as “functional group reactive to oxazoline group”) is preferably as low as possible. When concentration of such functional group in a core part is low, cross-linking within the same particles constituting the emulsion is suppressed; on the contrary, reactivity to other polymer (B) as described later is improved. In this connection, the functional group reactive to oxazoline group includes, for example, a carboxyl group, aromatic thiol group and phenolic hydroxyl group.

Supplying form of the polymer (A) constituting the fine particles as a core part is preferably a form of emulsion. Since the resin composition of the present invention is desirably aqueous in consideration of the environment, the polymer (A) constituting the fine particles preferably takes a form of emulsion.

For example, the polymer layer containing an oxazoline group to be formed in the outer layer of the core part as a shell part is provided as a resin composition layer consisting of a polymer obtained by polymerizing an additionally polymerizable oxazoline (a) and at least one type of other monomer (b), if necessary.

The additionally polymerizable oxazoline to be used in the present invention is represented by the general formula (I):

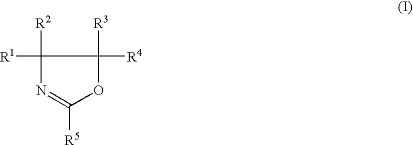

wherein, each of R¹, R², R³ and R⁴ independently represents a hydrogen, halogen, alkyl, phenyl or substituted phenyl group, and R⁵ represents an acyclic organic group having an additionally polymerizable unsaturated bond.

Specific examples of said additionally polymerizable oxazoline include, for example, 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline and 2-isopropenyl-5-ethyl-2-oxazoline, and a mixture of one or more types selected from the above group may be used. Among them, 2-isopropenyl-2-oxazoline is preferable due to easy industrial availability. Amount of the additionally polymerizable oxazoline (a) to be used is not particularly limited, but preferably content of the additionally polymerizable oxazoline in the shell part is not less than 1% by weight. A content less than 1% by weight results in providing an insufficient cross-linking ability. Amount of the additionally polymerizable oxazoline (a) to be used is more preferably 5 to 50% by weight, and most preferably 8 to 30% by weight.

The other monomer (b) to be used in the present invention is not particularly limited, so long as the monomer does not react with an oxazoline group but can copolymerize with the additionally polymerizable oxazoline (a). The monomer exemplified as a raw material for fine particles constituting the core part may be similarly used.

The reactive emulsion of the present invention is produced by, for example, an emulsion polymerization process. Details of the emulsion polymerization process can be referred to the conventionally known knowledge. For example, the emulsion polymerization can be performed using the well-known process such as a multi-stage feeding method or a power feeding method.

More specifically, in the first step of the emulsion polymerization, a monomer for the polymer (A) is subjected to an emulsion polymerization in the presence of an emulsifier. Thereby, the fine particles as the core part of the present invention are formed. In this occasion, preferably a monomer having a functional group reactive to an oxazoline group is not used.

In a subsequent latter step of emulsion polymerization, a monomer or a monomer mixture composed of the additionally polymerizable oxazoline (a) as an essential monomer and at least one type of other monomer (b) if necessary is incorporated and subjected to emulsion polymerization onto the core part formed in the first step of the emulsion polymerization. Thereby, a polymer layer containing an oxazoline group is formed in the outer layer of the core part. As the other monomer (b), a monomer similar to the monomer for the polymer (A) can be used.

In this connection, when the emulsion polymerization is two-stage polymerization, since the shell part is a single layer, said shell part can contain the polymer containing an oxazoline group. On the other hand, when the emulsion polymerization is three-stage polymerization or more, the shell part becomes two or more layers. In such a case, preferably a shell part located in the outermost layer contains the polymer containing an oxazoline group. However, the present invention is not limited to an embodiment in which only the outermost layer contains the polymer containing an oxazoline group, but the shell part in an inner layer may, of course, contain the polymer containing an oxazoline group. Further, when the emulsion polymerization is conducted using a power feeding method, content of the polymer containing an oxazoline group preferably increases from the core side toward the surface side of the shell part.

Polymerization initiator is not particularly limited, and includes, for example, peroxides such as hydrogen peroxide, potassium persulfate, sodium persulfate, ammonium persulfate, benzoyl peroxide, lauroyl peroxide, dicumyl peroxide, di-t-butyl peroxide, cumene hydroperoxide, t-butyl hydroperoxide and diisopropylbenzene hydroperoxide; and azo compounds such as 2,2′-azobisisobutylonitrile, 2,2′-azobis-(2,4-dimethylvaleronitrile), azobiscyanovaleric acid and 2,2′-azobis-(2-amidinopropane)•2hydrochloride. Also, a redox initiator system using a reducing agent and, if necessary, a chelating agent together with the above polymerization initiator may be used. The reducing agent includes, for example, alkaline metal formaldehyde sulfoxylates such as rongalit (sodium sulfoxylate formaldehyde); sulfites such as sodium sulfite and sodium hydrogen sulfite; pyrosulfites such as sodium pyrosulfite; thiosulfates such as sodium thiosulfate; phosphites such as sodium phosphite; pyrophosphites such as sodium pyrophosphite; mercaptanes; ascorbates such as ascorbic acid and sodium ascorbate; erythorbates such as erythorbic acid and sodium erythorbate; saccharides such as glucose and dextrose; metal salts such as ferrous sulfate and copper sulfate, etc. The chelating agent includes sodium pyrophosphate, ethylenediaminetetraacetate, etc. Amounts of these agents to be used are determined, as appropriate, depending on each initiator system.

In the emulsion of the present invention, ratio by weight of the core part and the shell part is not particularly limited, but ratio of the shell part is preferably 1 to 900 parts by weight, more preferably 10 to 200 parts by weight, and further more preferably 20 to 150 parts by weight to 100 parts by weight of the core part. A ratio less than 1 part by weight results in insufficiency in cross-linking ability, whereas a ratio greater than 900 parts by weight results in impairing an adhesive property to a substrate.

The above-described reactive emulsion of the present invention is incorporated to an emulsion composition together with, for example, other polymer. In this composition, the reactive emulsion of the present invention acts as a cross-linking agent to cross-link the above-described other polymer. Specifically, cross-linking proceeds by reaction of the oxazoline group present centering in the shell part of the emulsion of the present invention with a cross-linkable group in the other polymer.

The “other polymer” to be incorporated is not particularly limited, and any conventionally well-known polymer can be used. However, a polymer having a functional group reactive to an oxazoline group is preferably used. Such polymer includes, for example, a polymer containing a carboxyl group. As the polymer containing a carboxyl group, the following polymers are exemplified: for example, a polymer having a plurality of carboxyl groups as a branched chain obtained by polymerizing at least a monomer component containing an unsaturated carboxylic acid; a condensation resin containing a carboxyl group as a terminal and/or a pendant group; and a polymer with a carboxyl group introduced by post-modification. Specifically, the polymer includes acrylate-based resin, styrene-containing resin, polyester resin, alkyd resin, polyamide resin, polyurethane resin and polyolefin resin, containing a carboxyl group.

As described above, a polymer containing a carboxyl group was exemplified. However, the polymer having a functional group reactive to an oxazoline group is not limited to the polymer containing a carboxyl group, but a polymer containing an aromatic thiol group or a phenolic hydroxyl group, etc. can be used. In this connection, the polymer may be used alone or in combination of two or more members thereof.

Since the emulsion composition of the present invention is preferably aqueous in consideration of the environment, the “other polymer” is preferably water-soluble, water-miscible or water-dispersible. Supplying form of the “other polymer” is not particularly limited, but the “other polymer” is also preferably in a form of aqueous solution or emulsion in consideration of the environment. In this connection, in such a case, when the above-described other polymer is present in greater amount than the reactive emulsion of the present invention in the composition, in some cases said composition does not have an appearance nor a character of emulsion at the first glance. However, even in such a case, the composition is included in the emulsion composition of the present invention, so long as the reactive emulsion of the present invention is contained therein.

The emulsion composition of the present invention may contain solvent, plasticizer, inorganic or organic filler, coloring pigment, dye, thickener, dispersant, moistening agent, antifoaming agent, antiseptic or fungicidal agent, antirust, etc. within a range not to impair the object of the present invention, if necessary.

Amount of each component to be incorporated in the emulsion composition of the present invention is not particularly limited. As an example, around 1 to 99% by weight of the reactive emulsion of the present invention and around 1 to 99% by weight of other polymer (for example, a polymer containing a carboxyl group) to the total amount of the emulsion composition are contained. Further, when the other polymer is a polymer containing a carboxyl group, ratio of a content of an oxazoline group (Ox group) present in the shell part of the reactive emulsion of the present invention and a content of a carboxyl group (COOH group) of the above-described other polymer, (Ox group)/(COOH group), is preferably 1/100 to 100/1, and more preferably a ratio as close to as 1/1, because cross-linking ability can be more improved.

Process for producing the emulsion composition of the present invention is not particularly limited, and common means known by those skilled in the art can be widely applied. For example, to the reactive emulsion of the present invention, other polymer and other additives may be added and mixed, as appropriate. In addition, when the emulsion composition is used for coating material, surface treatment agent, coating agent, adhesive, sealant, etc., the composition may be applied to a substrate using a common method known by those skilled in the art such as roll coating, spraying, dipping, brush coating, etc.

The above-described emulsion composition of the present invention can be extremely effectively applied to various applications such as coating material, surface treatment agent, coating agent, adhesive and sealant. Among them, the emulsion composition is used preferably as a resin composition for processing cellulose-based substrate. Namely, the emulsion composition of the present invention is used for binders for pigment printing, textile-processing agents, coating or dipping processing agents, adhesives, coating agents, etc. for processing cellulose-based substrates such as cotton textile.

As described above, the emulsion composition of the present invention contains the reactive emulsion of the present invention and other polymer (for example, a polymer containing a carboxyl group). Details of each component to be contained therein are as described above.

In this connection, the resin composition for processing cellulose-based substrate of the present invention preferably further contains a compound (C) having a functional group reactive to both of a hydroxyl group and a functional group reactive to an oxazoline group. Such compound may be, for example, a compound having a functional group reactive to both of a hydroxyl group and a functional group reactive to an oxazoline group, or a compound having both of a functional group reactive to a hydroxyl group and a functional group reactive to a functional group reactive to an oxazoline group. In this connection, the functional group reactive to both of a hydroxyl group and a functional group reactive to an oxazoline group includes, for example, isocyanate group, epoxy group, methylol group and carbodiimide group. Further, in addition to these functional groups, the functional group reactive to a hydroxyl group includes, for example, aldehyde group and acid anhydride group. Still in addition to these functional groups, the functional group capable of reacting to a functional group reactive to an oxazoline group includes, for example, aziridinyl group in addition to the oxazoline group. As described above, the compound (C) includes isocyanate compound and polyvalent epoxy compound. Among them, isocyanate compound is preferable, and blocked isocyanate compound is particularly preferable. This is because the following reasons. Namely, when the resin composition of the present invention is used in an aqueous system, an unblocked isocyanate compound can not be expected to provide the effect of the present invention because the isocyanate group is labile to hydrolysis in water, and also maintenance of performance during storage for a long period can not be expected from the same reason. The blocked isocyanate compound includes blocked forms of, for example, toluenediisocyanate (TDI), 4,4′-diphenylmethanediisocyanate (pure MDI), MDI polymer, xylene diisocyanate (XDI), naphthalene diisocyanate (NDI), hexamethylene diisocyanate (HDI), isophorone diisocyanate (IPDI), hydrogenated XDI and hydrogenated MDI, and the blocking agent includes, for example, phenol, ε-caprolactam, methyl ethyl ketoxime and active methylene compound. Particularly preferable blocked isocyanate compound is a blocked isocyanate compound which dissociates at 100 to 150° C. When a blocked isocyanate compound dissociating at a temperature lower than 100° C. is used, the resin composition becomes worse in storage stability, and might gelate. Contrary, when a blocked isocyanate compound dissociating at a temperature higher than 150° C. is used, an addition effect in a low temperature treatment can not be expected.

Amount of the compound (C) to be incorporated in the resin composition of the present invention is preferably 5 to 2,000% by weight, more preferably 10 to 500% by weight, and further more preferably 25 to 200% by weight to the reactive emulsion of the present invention. When a incorporating amount of the compound (C) is less than 5% by weight, an addition effect thereof can not be expected, whereas when a incorporating amount of the compound (C) is more than 2,000% by weight, yellowing and performance deterioration of the composition might occur due to a long period of storage.

The resin composition for processing a cellulose-based substrate of the present invention preferably further contains at least one of a compound having a functional group capable of forming a carboxyl group by reacting with a hydroxyl group, or a compound having a functional group capable of reacting to a hydroxyl group and a carboxyl group. The functional group capable of forming a carboxyl group by reacting with a hydroxyl group includes, for example, acid anhydride. Further, the functional group capable of reacting to a hydroxyl group includes, for example, aldehyde group, epoxy group, isocyanate group, methylol group and carbodiimide group, in addition to acid anhydride group.

In this case, preferably the resin composition of the present invention contains a compound containing an acid anhydride group. The compound containing an acid anhydride group may be a compound of low molecular weight or a polymer. Further, in the compound containing an acid anhydride group, the acid anhydride groups may be fully or partly opened or converted to a monoester or a monoamide form. In this connection, opened form of the acid anhydride group means a compound having the acid anhydride group opened by hydrolysis, that is, a compound having vicinal carboxyl groups.

The low molecular weight compound containing an acid anhydride group includes, for example, maleic ahhydride, citraconic anhydride, succinic ahhydride, tetrapropenyl succinic anhydride, trimellitic anhydride, pyromellitic anhydride, glutaric anhydride, diglycolic anhydride, butanetetracarboxylic anhydride, and fully or partly ring-opened compound, monoester and monoamide thereof.

The polymer containing an acid anhydride group includes a polymer containing, as an essential repeating unit, repeating unit derived from one or more types of monomer selected from ethylenically unsaturated dicarboxylic anhydrides, and fully or partly ring-opened compounds, monoester and monoamide thereof. These polymers can be obtained by polymerizing monomer components containing, as an essential components, one or more types of the monomers, or polymerizing monomer component containing, as an essential component, only an ethylenically unsaturated dicarboxilic anhydride, and fully or partly converting said unsaturated dicarboxylic anhydride group to a ring-opened form or a monoester or a monoamide group, during or after the polymerization. Such monomer includes itaconic anhydride, maleic anhydride, citriconic anhydride, and ring-opened, monoester or monoamide form thereof. Such polymer includes, for example, styrene-maleic anhydride copolymer and isobutylene-maleicanhydride copolymer. Further, a polymer with an acid anhydride group introduced by post-modification can also be used. Such polymer includes, for example, polyolefin modified with maleic anhydride, polymer grafted with maleic anhydride, and fully or partly ring-opened, monoester or monoamide form of the acid anhydride group contained in these polymers. In this connection, number of acid anhydride group of the compound containing an acid anhydride group is preferably two or more.

The resin composition of the present invention may contain various additives other than the above, as appropriate. For example, solvent, plasticizer, inorganic or organic filler, coloring pigment, dye, thickener, dispersant, moistening agent, antifoaming agent, antisepticor fungicidal agent or antirust may be added therein. Further, in addition to these agents, washing resistance of the resin composition of the present invention can be improved by adding an aqueous elastomer such as SBR and polyurethane elastomer, as appropriate. Amount of the aqueous elastomer to be used is preferably 2 to 50% by weight, and more preferably 5 to 10% by weight to the amount of the other polymer (for example, a polymer containing a carboxyl group) used.

The resin composition of the present invention is preferably aqueous in consideration of the environment, etc. as described above, therefore, water is preferably used as a solvent.

The resin composition of the present invention is preferably used for processing a cellulose-based substrate. The cellulose-based substrate, which is processed with the resin composition of the present invention, is a substrate composed of materials containing cellulose. Form of the substrate includes, for example, fiber, film and plate-like. Specifically, the substrate includes cotton, blended cotton fabric (referred to blended yarn fabric of cotton and various types of synthetic fiber, specifically cotton/polyester blended yarn fabric, hereinafter the same), wood, paper, pulp and hemp, as well as cellulose derivatives (for example, nitrocellulose, celluloid, cellulose lacquer, acetyl cellulose, methyl cellulose, ethyl cellulose, benzyl cellulose, viscose rayon, CMC and HEC), substrate containing these materials and substrate coated with these materials.

Application of the processed cellulose-based substrate includes, specifically, binder for pigment printing, textile processing agent, coating or dipping processing agent, adhesive, coating agent, and the like.

### EXAMPLES

Next, the present invention will be further explained in detail using Examples and Comparative Examples. In this connection, “parts” and “%” in the following Examples are parts by weight and % by weight, unless otherwise noted.

### Production Example 1

### Synthesis Example of Emulsion of Aclylate-Based Resin Containing a Carboxyl Group

Into a flask equipped with a stirrer, a reflux condenser, a nitrogen gas introducing tube and a thermometer, deionized water (623.9 parts) and 15% aqueous solution of Hitenol N-08 (ammonium polyoxyethylene nonylphenyl ether sulfate salt from Daiich Kogyo Seiyaku Co., Ltd.) (14.0 parts) were charged. The mixture was heated to 70° C. while nitrogen gas was gently passed. A 2% aqueous solution of potassium persulfate (126 parts) was poured thereto, subsequently a monomer mixture composed of styrene (336.0 parts), butyl acrylate (470.4 parts), acrylic acid (33.6 parts), 15% N-08 aqueous solution (126.0 parts) and deionized water (154 parts), prepared in advance, was added drop-wise over 3 hours. Nitrogen gas was kept to pass during the reaction, and a temperature in the flask was maintained at 70±1° C. The reaction mixture was maintained at the same temperature for 2 hours after completion of the drop-wise addition, followed by increasing the internal temperature to 80° C. and stirring for 1 hour to complete the reaction. Thereafter, the reaction mixture was cooled, adjusted to pH 8.5 with a proper amount of aqueous ammonia to obtain an emulsion of acrylate-based resin containing a carboxyl group (non-volatile matter: 40.0% by weight) (theoretical acid content: 0.56 mmol/g·solid).

### Example 1

### Synthesis Example of Emulsion of Two Stage Type Acrylate-Based Resin Containing an Oxazoline Group (1): Core/Shell Ratio=5/5

Into a 1 L separable flask equipped with a stirrer, a reflux condenser, a nitrogen gas introducing tube and a thermometer, a deionized water (228.1 parts), a 25% aqueous solution of a surfactant Hitenol N-08 (from Daiichi Kogyo Seiyaku Co., Ltd.) (1.23 parts), and 7% aqueous ammonia (1.9 parts) were charged. The mixture was heated to 70° C. while nitrogen gas was gently passed. After temperature reached 70° C., 10% of a pre-emulsion composed of butyl acrylate (141.8 parts), styrene (133.2 parts), divinylbenzene (0.3 parts), deionized water (79.2 parts), 25% aqueous solution of Hitenol N-08 (15.5 parts), and 7% aqueous ammonia (0.3 parts), prepared for the first stage, was added thereto, as an initial charge. Subsequently, an aqueous solution of initiator prepared by dissolving potassium persulfate (2.8 parts) in pure water (34.4 parts) was added to start the polymerization. Further, remaining pre-emulsion for the first stage was added drop-wise thereto over 1.3 hours to promote the reaction with stirring. After 10 minutes from completion of the drop-wise addition, a pre-emulsion for the second stage composed of butyl acrylate (141.8 parts), styrene (78.2 parts), divinylbenzene (0.3 parts), 2-isopropenyl-2-oxazoline (55.1 parts), deionized water (79.2 parts), 25% aqueous solution of Hitenol N-08 (15.5 parts), and 7% aqueous ammonia (0.3 parts) was added drop-wise thereto over 1.3 hours to promote the reaction with stirring. After completion of the addition of the second stage, the reaction mixture was matured at 80° C. for 2.5 hours. After completion of the reaction, the reaction mixture was adjusted to pH 8.7 by adding 7% aqueous ammonia (1.4 parts) to obtain an emulsion of acrylate-based resin containing an oxazoline group (non-volatile matter: 55.6% by weight) (theoretical oxazoline group equivalent: 0.90 mmol/g).

### Example 2

### Synthesis Example of Emulsion of Two Stage Type Acrylate-Based Resin Containing Oxazoline Group (2): Core/Shell Ratio=6/4

Into a 1 L separable flask equipped with a stirrer, a reflux condenser, a nitrogen gas introducing tube and a thermometer, a deionized water (228.1 parts), a 25% aqueous solution of a surfactant Hitenol N-08 (from Daiichi Kogyo Seiyaku Co., Ltd.) (1.23 parts), and 7% aqueous ammonia (1.9 parts) were charged. The mixture was heated to 70° C. while nitrogen gas was gently passed. After temperature reached 70° C., 10% of a pre-emulsion composed of butyl acrylate (170.1 parts), styrene (159.9 parts), divinylbenzene (0.4 parts), deionized water (95.0 parts), 25% aqueous solution of Hitenol N-08 (18.6 parts), and 7% aqueous ammonia (0.4 parts), prepared for the first stage, was added thereto, as an initial charge. Subsequently, an aqueous solution of initiator prepared by dissolving potassium persulfate (2.8 parts) in pure water (34.4 parts) was added to start the polymerization. Further, remaining pre-emulsion for the first stage was added drop-wise thereto over 1.3 hours to promote the reaction with stirring. After 10 minutes from completion of the drop-wise addition, a pre-emulsion for the second stage composed of butyl acrylate (113.4 parts), styrene (62.5 parts), divinylbenzene (0.2 parts), 2-isopropenyl-2-oxazoline (44.1 parts), deionized water (63.4 parts), 25% aqueous solution of Hitenol N-08 (12.4 parts), and 7% aqueous ammonia (0.2 parts) was added drop-wise thereto over 1.3 hours to promote the reaction with stirring. After completion of the addition of the second stage, the reaction mixture was matured at 80° C. for 2.5 hours. After completion of the reaction, the reaction mixture was adjusted to pH 8.9 by adding 7% aqueous ammonia (1.4 parts) to obtain an emulsion of acrylate-based resin containing an oxazoline group (non-volatile matter: 55.6% by weight) (theoretical oxazoline group equivalent: 0.72 mmol/g).

### Example 3

### Synthesis Example of Emulsion of Two Stage Type Acrylate-Based Resin Containing Oxazoline Group (3): Core/Shell Ratio=7/3

Into a 1 L separable flask equipped with a stirrer, a reflux condenser, a nitrogen gas introducing tube and a thermometer, a deionized water (228.1 parts), a 25% aqueous solution of a surfactant Hitenol N-08 (from Daiichi Kogyo Seiyaku Co., Ltd.) (1.23 parts), and 7% aqueous ammonia (1.9 parts) were charged. The mixture was heated to 70° C. while nitrogen gas was gently passed. After temperature reached 70° C., 10% of a pre-emulsion composed of butyl acrylate (198.5 parts), styrene (186.6 parts), divinylbenzene (0.4 parts), deionized water (110.9 parts), 25% aqueous solution of Hitenol N-08 (21.7 parts), and 7% aqueous ammonia (0.4 parts), prepared for the first stage, was added thereto, as an initial charge. Subsequently, an aqueous solution of initiator prepared by dissolving potassium persulfate (2.8 parts) in pure water (34.4 parts) was added to start the polymerization. Further, remaining pre-emulsion for the first stage was added drop-wise thereto over 1.3 hours to promote the reaction with stirring. After 10 minutes from completion of the drop-wise addition, a pre-emulsion for the second stage composed of butyl acrylate (85.1 parts), styrene (46.9 parts), divinylbenzene (0.2 parts), 2-isopropenyl-2-oxazoline (33.1 parts), deionized water (47.5 parts), 25% aqueous solution of Hitenol N-08 (9.3 parts), and 7% aqueous ammonia (0.2 parts) was added drop-wise thereto over 1.3 hours to promote the reaction with stirring. After completion of the addition of the second stage, the reaction mixture was matured at 80° C. for 2.5 hours. After completion of the reaction, the reaction mixture was adjusted to pH 8.8 by adding 7% aqueous ammonia (1.4 parts) to obtain an emulsion of acrylate-based resin containing an oxazoline group (non-volatile matter: 55.6% by weight) (theoretical oxazoline group equivalent: 0.54 mmol/g).

### Example 4

### Synthesis Example of Emulsion of Two Stage Type Acrylate-Based Resin Containing Oxazoline Group (3): Core/Shell Ratio=5/5

Into a 1 L separable flask equipped with a stirrer, a reflux condenser, a nitrogen gas introducing tube and a thermometer, a deionized water (228.1 parts), a 25% aqueous solution of a surfactant Hitenol N-08 (from Daiichi Kogyo Seiyaku Co., Ltd.) (1.23 parts), and 7% aqueous ammonia (1.9 parts) were charged. The mixture was heated to 70° C. while nitrogen gas was gently passed. After temperature reached 70° C., 10% of a pre-emulsion composed of butyl acrylate (141.8 parts), styrene (133.2 parts), divinylbenzene (0.3 parts), deionized water (79.2 parts), 25% aqueous solution of Hitenol N-08 (15.5 parts), and 7% aqueous ammonia (0.3 parts), prepared for the first stage, was added thereto, as an initial charge. Subsequently, an aqueous solution of initiator prepared by dissolving potassium persulfate (2.8 parts) in pure water (34.4 parts) was added to start the polymerization. Further, remaining pre-emulsion for the first stage was added drop-wise thereto over 1.3 hours to promote the reaction with stirring. After 10 minutes from completion of the drop-wise addition, a pre-emulsion for the second stage composed of butyl acrylate (141.8 parts), styrene (50.6 parts), divinylbenzene (0.3 parts), 2-isopropenyl-2-oxazoline (82.7 parts), deionized water (79.2 parts), 25% aqueous solution of Hitenol N-08 (15.5 parts), and 7% aqueous ammonia (0.3 parts) was added drop-wise thereto over 1.3 hours to promote the reaction with stirring. After completion of the addition of the second stage, the reaction mixture was matured at 80° C. for 2.5 hours. After completion of the reaction, the reaction mixture was adjusted to pH 8.7 by adding 7% aqueous ammonia (1.4 parts) to obtain an emulsion of acrylate-based resin containing an oxazoline group (non-volatile matter: 55.6% by weight) (theoretical oxazoline group equivalent: 1.35 mmol/g).

### Comparative Example 1

### Synthesis Example of Emulsion of One Stage Type Acrylate-Based Resin Containing Oxazoline Group (1)

Into a 1 L separable flask equipped with a stirrer, a reflux condenser, a nitrogen gas introducing tube and a thermometer, a deionized water (228.1 parts), a 25% aqueous solution of a surfactant Hitenol N-08 (from Daiichi Kogyo Seiyaku Co., Ltd.) (1.23 parts), and 7% aqueous ammonia (1.9 parts) were charged. The mixture was heated to 70° C. while nitrogen gas was gently passed. After temperature reached 70° C., 10% of a pre-emulsion composed of butyl acrylate (283.5 parts), styrene (211.4 parts), divinylbenzene (0.6 parts), 2-isopropenyl-2-oxazoline (55.1 parts), deionized water (158.4 parts), 25% aqueous solution of Hitenol N-08 (31.0 parts), and 7% aqueous ammonia (0.6 parts) was added thereto, as an initial charge. Subsequently, an aqueous solution of initiator prepared by dissolving potassium persulfate (2.8 parts) in pure water (34.4 parts) was added to start the polymerization. Further, remaining pre-emulsion was added drop-wise thereto over 2.5 hours to promote the reaction with stirring. After completion of the addition, the reaction mixture was matured at 80° C. for 2.5 hours. After completion of the reaction, the reaction mixture was adjusted to pH 8.8 by adding 7% aqueous ammonia (1.4 parts) to obtain an emulsion of acrylate-based resin containing an oxazoline group (non-volatile matter: 55.6% by weight) (theoretical oxazoline group equivalent: 0.90 mmol/g).

### Examples 5 to 8 and Comparative Example 2

With the compositions as shown in Table 1 (all incorporating ratios are based on ratio by weight, unless otherwise noted), the emulsion of acrylate-based resin containing an oxazoline group and the emulsion of acrylate-based resin containing a carboxyl group were mixed to prepare curable compositions. Using these curable compositions, xylene swelling rate test was conducted as described below.

### (Evaluation Method)

### Xylene Swelling Rate

Each of curable compositions was casted on a tetrafuluoroethylene resin plate under the conditions of 23° C., 65% RH, and left for standing for one day to obtain a film with a thickness of about 0.3 mm, which was used as a test piece. Each test piece was, after cured under the curing conditions as prescribed, immersed in xylene for 24 hours at room temperature, and swelling rate thereof was calculated according to the following formula. Smaller value of the swelling rate means better solvent resistance.

Swelling rate (%)=[(weight after immersion−weight before immersion)/(weight before immersion)]×100

TABLE 1

| | Example | Example | Example | Example | Comp. |
|---|---|---|---|---|---|
| | 5 | 6 | 7 | 8 | Example 2 |
| Emulsion of | 100 | 100 | 100 | 100 | 100 |
| acrylate-based resin | | | | | |
| containing a carboxyl group | | | | | |
| Emulsion of | 3.6 | | | | |
| two stage type acrylate-based | | | | | |
| resin containing an oxazoline | | | | | |
| group (1): | | | | | |
| Core/shell ratio = 5/5 | | | | | |
| Emulsion of | | 3.6 | | | |
| two stage type acrylate-based | | | | | |
| resin containing an oxazoline | | | | | |
| group (2): | | | | | |
| Core/shell ratio = 6/4 | | | | | |
| Emulsion of | | | 3.6 | | |
| two stage type acrylate-based | | | | | |
| resin containing an oxazoline | | | | | |
| group (3): | | | | | |
| Core/shell ratio = 7/3 | | | | | |
| Emulsion of | | | | 3.6 | |
| two stage type acrylate-based | | | | | |
| resin containing an oxazoline | | | | | |
| group (4): | | | | | |
| Core/shell ratio = 5/5 | | | | | |
| Emulsion of | | | | | 3.6 |
| one stage type acrylate-based | | | | | |
| resin containing an oxazoline | | | | | |
| group (1): | | | | | |
| Molar ratio of functional | 0.08 | 0.064 | 0.048 | 0.12 | 0.08 |
| groups: | | | | | |
| (Ox/COOH) | | | | | |
| Weight ratio of resins: | 0.05 | 0.05 | 0.05 | 0.05 | 0.05 |
| (Ox/COOH) | | | | | |
| Xylene swelling rate (%) | 1,150 | 1,250 | 1,450 | 930 | 2,070 |
| (curing conditions: 120° C. × | | | | | |
| 30 min.) | | | | | |
| Xylene swelling rate (%) | 2,600 | 2,800 | 3,200 | 1,400 | dissolved |
| (curing conditions: 80° C. × | | | | | |
| 30 min.) | | | | | |

From the results shown in Table 1, the core-shell type reactive emulsion of the present invention is found to exhibit a low value of xylene swelling rate, that is, exert a superior solvent resistance when used as a curable composition.

### Examples 9 to 12 and Comparative Examples 3 and 4

The emulsion of acrylate-based resin containing an oxazoline group (those prepared in the above Example 1 and Comparative Example 1), the emulsion of acrylate-based resin containing a carboxyl group, and other compounds if necessary were mixed with the compositions as shown in the following Table 2 (all incorporating ratios are based on ratio by weight, unless otherwise noted) to prepare resin compositions for processing cellulose-based substrate. Using these curable compositions, paper impregnation treatment was carried out to determine tensile strengths.

### (Impregnation Conditions)

An aqueous solution containing 1% by weight of each composition was sufficiently impregnated into a substrate (filter paper: #1, from Advantech Co., Ltd., rectangular, 15 mm×250 mm), then subjected to a heat treatment at 120° C. for 30 minutes to obtain a test piece.

### (Measuring Conditions of Tensile Strength)

The test piece was stored in a temperature and humidity controlled chamber (temperature: 25° C., humidity: 60% RH) for 24 hours, and tensile strength was measured according to JIS P 8113. The results of the measurement are shown in the following Table 2.

TABLE 2

| | | | | | Comp. | Comp. |
|---|---|---|---|---|---|---|
| | Example | Example | Example | Example | Example | Example |
| | 9 | 10 | 11 | 12 | 3 | 4 |
| Emulsion of | 25 | 25 | 25 | 25 | 25 | 25 |
| Acrylate-based resin | | | | | | |
| Containing a carboxyl | | | | | | |
| group | | | | | | |
| Emulsion of | 2 | 2 | 2 | 2 | | |
| two stage type | | | | | | |
| acrylate-based resin | | | | | | |
| containing an | | | | | | |
| oxazoline group (1): | | | | | | |
| Core/shell ratio = 5/5 | | | | | | |
| Emulsion of | | | | | | 2 |
| one stage type | | | | | | |
| acrylate-based resin | | | | | | |
| Containing an | | | | | | |
| oxazoline group (1): | | | | | | |
| Styrene - maleic | | 2 | | | | |
| anhydride | | | | | | |
| copolymer¹⁾ | | | | | | |
| Pyromellitic acid²⁾ | | | 4 | | | |
| Glyoxylic acid³⁾ | | | | 2 | | |
| Tensile strength | 77 | 81 | 83 | 80 | 60 | 72 |
| (kgf/cm²) | | | | | | |

¹⁾SMA 1000P (From Elf Atochem) was neutralized with ammonia and used as a 50% by weight aqueous solution.
²⁾From Wako Pure Chemical Industries Ltd., neutralized with ammonia, and used as a 25% by weight aqueous solution.
³⁾From Wako Pure Chemical Industries Ltd., neutralized with ammonia, and used as a 50% by weight aqueous solution.

From the results shown in Table 2, the core-shell type reactive emulsion of the present invention is found to exhibit a high value of tensile strength, that is, exert a superior strength, when used as a resin composition for processing cellulose-based substrate.

The above Examples are to more specifically explain the present invention, and the present invention should not be construed to be limited to the Examples.

The present application is based on Japanese Patent Application No. 2005-122442 filed on Apr. 20, 2005, the disclosure thereof is incorporated herein in entirety by reference.

1. A reactive emulsion comprising a core part composed of fine particles of an acrylate-based emulsion, and a shell part composed of a polymer containing an oxazoline group, located around said core part.

2. An emulsion according to claim 1, wherein a ratio of said shell part to 100 parts by weight of said core part is 1 to 900 parts by weight.

3. An emulsion according to claim 1, wherein a ratio of an additionally polymerizable oxazoline in said shell part is not less than 1% by weight.

4. A process for producing a reactive emulsion, comprising a step of polymerizing a monomer or a monomer mixture comprising, as an essential component, an additionally polymerizable oxazoline with an acrylate-based emulsion in the presence of an emulsifier.

5. A process according to claim 4, wherein a ratio of a monomer or a monomer mixture comprising an additionally polymerizable oxazoline to 100 parts by weight of solid content of said acrylate-based emulsion is 1 to 900 parts by weight.

6. A process according to claim 4, wherein said monomer or monomer mixture comprises not less than 1% by weight of an additionally polymerizable oxazoline.

7. An emulsion composition comprising the reactive emulsion according to claim 1 and other polymer.

8. An emulsion composition according to claim 7, wherein said other polymer has, as an essential component, one or more functional groups selected from a group consisting of carboxyl group, aromatic thiol group and phenolic hydroxyl group.

9. A resin composition for processing a cellulose-based substrate comprising, as an essential component, the emulsion composition according to claim 7.

10. A resin composition for processing a cellulose-based substrate according to claim 9, wherein said composition further comprises a compound having a functional group capable of reacting with both of a hydroxyl group and one or more functional groups selected from a group consisting of carboxyl group, aromatic thiol group and phenolic hydroxyl group.

11. A resin composition for processing a cellulose-based substrate according to claim 9, wherein said composition further comprises, as an essential component, at least one of a compound having an acid anhydride group or a compound having a functional group capable of reacting with a hydroxyl group and a carboxyl group.

12. An emulsion according to claim 2, wherein a ratio of an additionally polymerizable oxazoline in said shell part is not less than 1% by weight.

13. A process according to claim 5, wherein said monomer or monomer mixture comprises not less than 1% by weight of an additionally polymerizable oxazoline.

14. An emulsion composition comprising the reactive emulsion according to claim 2 and other polymer.

15. An emulsion composition comprising the reactive emulsion according to claim 3 and other polymer.

16. A resin composition for processing a cellulose-based substrate comprising, as an essential component, the emulsion composition according to claim 8.

17. A resin composition for processing a cellulose-based substrate according to claim 10, wherein said composition further comprises, as an essential component, at least one of a compound having an acid anhydride group or a compound having a functional group capable of reacting with a hydroxyl group and a carboxyl group.
